(19) United States
(12) Patent Application Publication
(10) Pub. No.: US 2026/0027504 A1
(43) Pub. Date: Jan. 29, 2026

(54) METHOD AND APPARATUS FOR CONTROLLING AND CLEANING A COOKING HOOD

(71) Applicant: INTELLINOX INC., Québec (CA)

(72) Inventors: Mario Rousseau, Québec (CA); Alexandre Rousseau, Québec (CA); Jean Rousseau, Québec (CA); Marc Gretillat, Québec (CA)

(21) Appl. No.: 19/279,092

(22) Filed: Jul. 24, 2025

Related U.S. Application Data
(60) Provisional application No. 63/675,089, filed on Jul. 24, 2024.

(51) Int. Cl. B01D 46/79; B01D 39/20; B01D 45/08; B01D 46/00; B01D 46/44; B01D 50/20; F24C 15/20

(52) U.S. Cl. CPC B01D 46/79; B01D 39/2093; B01D 45/08; B01D 46/0047; B01D 46/009; B01D 46/446; B01D 50/20; F24C 15/2021; F24C 15/2035; F24C 15/2057; B01D 2273/30; B01D 2279/35

(57) ABSTRACT

A method to clean at least one secondary filter located inside an air filtration chamber of a ventilation system of a commercial kitchen is provided. The air filtration chamber is in gas communication with an exhaust conduit of the ventilation system. The method comprises: spraying a first liquid mixture including water and a cleaning agent towards an inlet surface of the at least one secondary filter; and spraying a second liquid mixture including water and a cleaning agent towards an outlet surface of the at least one secondary filter, wherein spraying the first liquid mixture and spraying the second liquid mixture is carried out sequentially. There is also provided a commercial cooking assembly comprising: at least one cooking appliance; and a ventilation system.

### CROSS-REFERENCE TO RELATED APPLICATION

This application claims priority under 35USC§ 119 (e) of US provisional patent application 63/675,089 filed Jul. 24, 2024, the specification of which is hereby incorporated by reference.

### TECHNICAL FIELD OF THE INVENTION

The technical field relates to ventilation systems for commercial kitchens. More particularly, it relates to commercial cooking assemblies including a ventilation system and a method to clean at least one secondary filter located inside an air filtration chamber of a ventilation system of a commercial kitchen.

### BACKGROUND

Ventilation systems used in commercial kitchens (i.e. restaurants, cafeterias, grocery stores, etc.) are generally used to exhaust large quantities of air which often contain a fairly high proportion of suspended solids, for example water vapor, smoke and dust particles, and grease/oils/fats, which emanate from cooking appliances.

Controlling the airflow and managing the accumulation of grease particles inside the ventilation system is one of the challenges. Most ventilation systems include a system of baffles through which the air flows and on which grease accumulates. It is known to spray water in combination with a degreasing agent onto the baffle system to remove grease particles, which accumulated thereon.

However, improved multi-stage filtration systems have been developed including a primary filter and a secondary filter mounted downstream to the primary filter. Therefore, novel cleaning methods and apparatuses are required. There is also a need to control the airflow within the ventilation system to improve the ventilation efficiency.

### BRIEF SUMMARY OF THE INVENTION

It is therefore an aim of the present invention to address the above-mentioned issues.

According to a general aspect, there is provided a commercial cooking assembly comprising: at least one cooking appliance; and a ventilation system. The ventilation system comprises: a ventilation hood mounted above the at least one cooking appliance; at least one primary filter mounted to the ventilation hood and delimitating therewith an air filtration chamber; at least one secondary filter located inside the air filtration chamber; an exhaust conduit in gas communication with the air filtration chamber; an exhaust air propeller generating an airflow at least between an air space located above the at least one cooking appliance, sequentially into the at least one primary filter and the at least one secondary filter located inside the air filtration chamber, and exiting through the exhaust conduit; and a pressure sensor located between the at least one primary filter and the at least one secondary filter. The pressure measured by the pressure sensor is indicative of the presence of the at least one primary filter.

In an embodiment, the at least one primary filter comprises a baffle filter.

In an embodiment, the at least one secondary filter comprises a foam filter, such as a ceramic-based filter.

According to another general aspect, there is provided a method to clean at least one secondary filter located inside an air filtration chamber of a ventilation system of a commercial kitchen, the air filtration chamber being in gas communication with an exhaust conduit of the ventilation system. The method comprises: spraying a first liquid mixture including water and a cleaning agent towards an inlet surface of the at least one secondary filter; and spraying a second liquid mixture including water and a cleaning agent towards an outlet surface of the at least one secondary filter.

In an embodiment, the method further comprises spraying a third liquid mixture including water and a cleaning agent towards the exhaust conduit of the ventilation system.

In an embodiment, the water sprayed towards the at least one secondary filter is hot water.

In an embodiment, the at least one secondary filter comprises a foam filter, such as a ceramic-based filter.

In an embodiment, the method further comprises, while spraying the first liquid mixture, generating an airflow through the at least one secondary filter, the airflow entering the at least one secondary filter through the inlet surface and exiting through the outlet surface. The airflow generated while spraying the first liquid mixture can be greater than the airflow generated while spraying the second liquid mixture.

In an embodiment, the ventilation system further comprises at least one primary filter delimitating at least partially the air filtration chamber and the method further comprises measuring a pressure between the at least one primary filter and the at least one secondary filter before spraying the first liquid mixture, wherein the measured pressure is indicative of the presence of the at least one primary filter, and spraying the first liquid mixture and the second liquid mixture solely when the at least one primary filter is present. The at least one primary filter can comprise a baffle filter. The method can further comprise varying the airflow when spraying the first liquid mixture. The ventilation system can further comprise a controllable shutter mounted in the exhaust conduit and the method further comprises varying an opening of the controllable shutter at a cycle ranging between about 1 and about 10 seconds. In an embodiment, the cycle ranges between about 2 and about 5 seconds to modify the airflow flowing through the at least one secondary filter. An opening of the controllable shutter can be varied from a closed configuration to an open configuration at each one of the cycle.

In an embodiment, the ventilation system further comprises an exhaust air propeller generating the airflow through the ventilation system and wherein the exhaust air propeller is characterized by a maximum airflow rate, and wherein the airflow rate when spraying the first liquid mixture ranges between about 0% to about 100% of the maximum airflow rate of the exhaust air propeller. The airflow rate when spraying the first liquid mixture can range between about 50% to about 100% of the maximum airflow rate of the exhaust air propeller. The airflow rate when spraying the second liquid mixture can range between about 0% to about 25% of the maximum airflow rate of the exhaust air propeller. In an embodiment, the airflow rate when spraying the third liquid mixture can range between about 75% to about 100% of the maximum airflow rate of the exhaust air propeller.

According to a further general aspect, there is provided a commercial cooking assembly including: at least a first cooking appliance and a second cooking appliance, the first cooking appliance having a first minimum ventilation requirement and the second cooking appliance having a second minimum ventilation requirement, wherein the first minimum ventilation requirement is lower than the second minimum ventilation requirement; a ventilation hood mounted above the first cooking appliance and the second cooking appliance and delimitating an air filtration chamber; at least one secondary filter located inside the air filtration chamber; an exhaust conduit in gas communication with the air filtration chamber; an exhaust air propeller generating an airflow at least between an air space located above the first cooking appliance and the second cooking appliance, the at least one secondary filter, and exiting through the exhaust conduit. The at least one secondary filter above the first cooking appliance has a smaller exposed inlet surface per length unit than the at least one secondary filter above the second cooking appliance.

In an embodiment, the at least one secondary filter comprises a foam filter, such as a ceramic-based filter.

In an embodiment, the at least one secondary filter located above the first and the second cooking appliances has a same surface area per length unit and the commercial cooking assembly further comprises at least one secondary filter obstructor mounted to the at least one secondary filter above the first cooking appliance to reduce the exposed inlet surface per length unit of the at least one secondary filter above the first cooking appliance. The at least one secondary filter can be characterized by a length and a depth and the at least one secondary filter obstructor reduces a depth of the at least one secondary filter above the first cooking appliance. The at least one secondary filter obstructor can comprise a plate superposed to an inlet surface of the at least one secondary filter.

According to a general aspect, there is provided a method to clean at least one secondary filter located inside an air filtration chamber of a ventilation system of a commercial kitchen, the air filtration chamber being in gas communication with an exhaust conduit of the ventilation system. The method comprises: spraying a first liquid mixture including water and a cleaning agent towards an inlet surface of the at least one secondary filter; and spraying a second liquid mixture including water and a cleaning agent towards an outlet surface of the at least one secondary filter, wherein spraying g the first liquid mixture and spraying the second liquid mixture is carried out sequentially.

In an embodiment, the method further comprises spraying a third liquid mixture including water and a cleaning agent towards the exhaust conduit of the ventilation system.

In an embodiment, the water sprayed towards the at least one secondary filter is hot water having a temperature greater than about 50° C.

In an embodiment, the at least one secondary filter comprises a ceramic-based foam filter.

In an embodiment, spraying the first liquid mixture is carried out before spraying the second liquid mixture.

In an embodiment, the method further comprises, while spraying the first liquid mixture, generating an airflow through the at least one secondary filter, the airflow entering the at least one secondary filter through the inlet surface and exiting through the outlet surface. The airflow generated while spraying the first liquid mixture can be greater than the airflow generated while spraying the second liquid mixture.

In an embodiment, the ventilation system further comprises at least one primary filter delimitating at least partially the air filtration chamber and the method further comprises measuring a pressure between the at least one primary filter and the at least one secondary filter before spraying the first liquid mixture, wherein the measured pressure is indicative of the presence of the at least one primary filter, and spraying the first liquid mixture and the second liquid mixture solely when the at least one primary filter is present. The at least one primary filter can comprise a baffle filter. The method can further comprise varying the airflow when spraying the first liquid mixture. The ventilation system can further comprise a controllable shutter mounted in the exhaust conduit and the method can further comprise varying an opening of the controllable shutter at a cycle ranging between about 1 and about 10 seconds when spraying the first liquid mixture. The cycle can range between about 2 and about 5 seconds to modify the airflow flowing through the at least one secondary filter. An opening of the controllable shutter can vary from a closed configuration to an open configuration at each one of the cycle.

The ventilation system can further comprise an exhaust air propeller generating the airflow through the ventilation system. The exhaust air propeller can be characterized by a maximum airflow rate. The airflow rate when spraying the first liquid mixture can range between about 0% to about 100% of the maximum airflow rate of the exhaust air propeller. The airflow rate when spraying the first liquid mixture can range between about 50% to about 100% of the maximum airflow rate of the exhaust air propeller. The airflow rate when spraying the second liquid mixture can range between about 0% to about 25% of the maximum airflow rate of the exhaust air propeller. The airflow rate when spraying the third liquid mixture can range between about 75% to about 100% of the maximum airflow rate of the exhaust air propeller.

According to another general aspect, there is provided a commercial cooking assembly comprising: at least one cooking appliance; and a ventilation system. The ventilation system comprises: a ventilation hood mounted above the at least one cooking appliance; at least one primary filter mounted to the ventilation hood and delimitating therewith an air filtration chamber; at least one secondary filter located inside the air filtration chamber; an exhaust conduit in gas communication with the air filtration chamber; an exhaust air propeller generating an airflow at least between an air space located above the at least one cooking appliance, sequentially into the at least one primary filter and the at least one secondary filter located inside the air filtration chamber, and exiting through the exhaust conduit; and a pressure sensor located between the at least one primary filter and the at least one secondary filter. The pressure measured by the pressure sensor is indicative of the presence of the at least one primary filter.

In an embodiment, the at least one primary filter comprises a baffle filter and the at least one secondary filter comprises a ceramic-based foam filter.

In an embodiment, the commercial cooking assembly further comprises a cleaning system including at least one upstream washing nozzle oriented towards an upstream surface of the secondary filter, a downstream washing nozzle oriented towards the exhaust conduit, a water supply, and a cleaning agent supply, wherein the upstream, downstream, and exhaust conduit washing nozzles are in liquid communication with the water supply and the cleaning agent supply.

In this specification, the term “grease” is intended to include oil and fat. In this specification, the term “cleaning agent” is intended to include degreasing agent.

In this specification, the term “primary filter” is intended to include an upstream filter assembly, such as a baffle or centrifugal filter. They can be designed to prevent flame propagation.

In this specification, the term “secondary filter” is intended to include a downstream filter assembly, i.e. downstream to the primary filter, including some type of filtering media. The secondary filter is positioned behind the primary filter, with respect to the airflow.

In this specification, without specified otherwise, reference to an airflow refers to a forced airflow, i.e. an airflow generated by a fan and/or a blower inside the ventilation system by opposition of a naturally occurring airflow due to sporadic pressure variations.

### BRIEF DESCRIPTION OF THE DRAWINGS

FIG. 1 is a schematic representation of a ventilation system for a commercial kitchen in accordance with an embodiment;

FIG. 2 is a flowchart of a method for cleaning a secondary filter located inside an air filtration chamber of the ventilation system of the commercial kitchen of FIG. 1, in accordance with an embodiment;

FIG. 3 is a flowchart of a method for cleaning a secondary filter located inside an air filtration chamber of the ventilation system of the commercial kitchen of FIG. 1, in accordance with another embodiment wherein a shutter is successively and quickly opened and closed;

FIG. 4 is a schematic representation of a commercial kitchen including a plurality of cooking appliances and its ventilation system in accordance with another embodiment; and

FIG. 5 is a photograph showing a secondary filter having a secondary filter obstructor superposed to an inlet surface thereof.

It will be noted that throughout the appended drawings, like features are identified by like reference numerals.

### DETAILED DESCRIPTION

Moreover, although the embodiments of the commercial kitchen, its ventilation and cleaning systems, and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the commercial kitchen, its ventilation and cleaning systems, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and correspond to the position and orientation of the ventilation system and corresponding parts with respect to the commercial kitchen. Positional descriptions should not be considered limiting.

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value. It is commonly accepted that a 10% precision measure is acceptable and encompasses the term “about”.

The devices and techniques described herein relate to commercial kitchen or fume hoods and commercial kitchen filtration systems, also known type I and type II hoods (NFPA 96-National Fire Protection Association-Standard for Ventilation Control and Fire Protection of Commercial Cooking Operations). In this context, a “ventilation hood” may refer to any duct or ductless ventilation system configured to vent away grease, oil, fat, moisture, smoke, etc. from a cooking surface or space. Accordingly, “a ventilation hood” may refer to a range hood, vent hood, exhaust hood, kitchen hood, kitchen exhaust system, kitchen ventilation system, ventilated ceilings, etc. The ventilation hoods described herein filter the airflow vented away from a cooking surface or space surrounding the cooking surface.

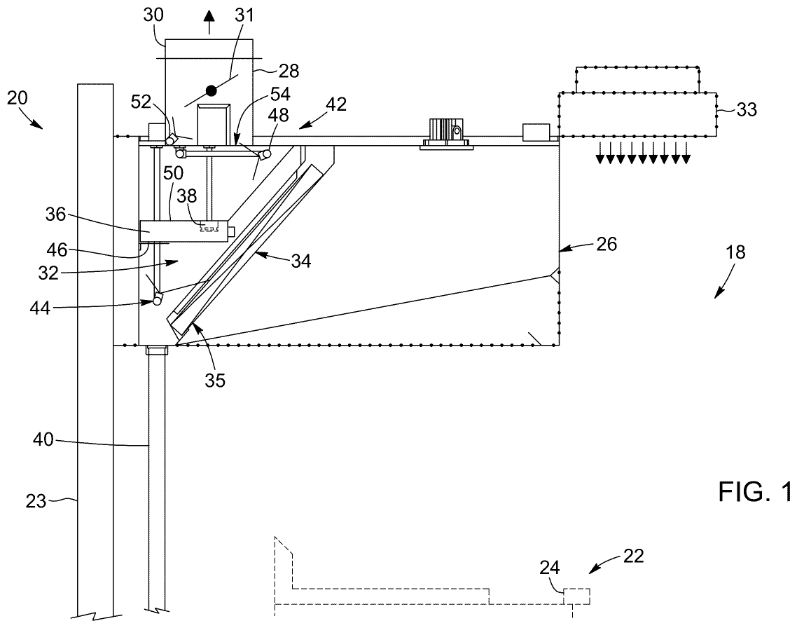

Referring now to FIG. 1, there is shown a non-limitative embodiment of a commercial cooking assembly 18 including a ventilation system 20 used in combination with a commercial kitchen 22. In the schematic representation of FIG. 1, only one cooking appliance 24 is shown in the commercial kitchen 22. However, it is appreciated that the commercial kitchen 22 can include more than one cooking appliance 24 associated to the ventilation system 20. The cooking appliances can be, for example, a hob, a stove, an oven, a kettle, a fryer or any other device which requires the evacuation of a relatively large quantity of air containing suspended matter, for example steam, smoke and grease particles, which emanate from one or more of these cooking appliances 24. All these materials, odors and combustion gases are evacuated by the ventilation system 20, which remove air from the commercial kitchen 22 to send it to the outside, i.e. a location outside of the commercial kitchen 22 itself. This may be the exterior of the building in which the commercial kitchen 22 is located, or another space inside the building containing the commercial kitchen 22, or even in another building. The removed air is evacuated through an air circuit including a ventilation hood 26 and an exhaust conduit 28 (only a segment thereof is shown in FIG. 1). It is appreciated that the exhaust conduit 28 is not necessarily rectilinear as shown. It can be made up of a several consecutive segments extending in different directions and being in gas communication.

The ventilation system 20 also includes a make-up air fan 33 (or an air propeller/blower). In the non-limitative embodiment, the make-up air fan 33 is located upstream the ventilation hood 26 and is in gas communication therewith. The make-up air fan 33 propels air in the commercial kitchen 22 and into the ventilation system 20 through the ventilation hood 26. The ventilation system can also include a hood exhaust fan 30 mounted to the roof of the building and connected to the outlet of the exhaust conduit 28. In such embodiment, the hood exhaust fan draws air into the exhaust conduit 28, reducing the internal pressure and generating a suction of air upstream into the ventilation hood 26. The exhaust fan 30 can be a conventional fan with a plurality of blades driven in rotation by a motor, for example an electric motor. In a non-limitative embodiment, the exhaust fan 30 is a variable speed fan to control the airflow rate inside the commercial kitchen 24 and the ventilation system 20.

Hereinafter, the terms “upstream” and “downstream” relate to position with respect to the airflow being used as reference, with a position upstream being closer to an inlet of the ventilation system 20 than a position downstream, which in turn is closer to the exhaust.

The ventilation hood 26 is located above the cooking appliance(s) 24 located in the commercial kitchen 22. The ventilation hood 26 is open from below and defines an air filtration chamber 32, downstream the ventilation hood 26 and upstream the exhaust conduit 28. The exhaust conduit 28 is in gas communication with the air filtration chamber 32, i.e. the airflow flowing through the ventilation hood 26 flow through the air filtration chamber 32 before reaching the exhaust conduit 28. Thus, the cooking appliance(s) is located below the ventilation hood 26. It is appreciated that the ventilation hood 26 can include more than one spaced-apart location where air is captured inside the commercial kitchen 22, instead of the one shown in the schematic example of FIG. 1.

To further regulate the airflow inside the commercial kitchen 24 and the ventilation system 20, the ventilation system 20 includes a controllable shutter 31 mounted inside the exhaust conduit 28 (or close to the exhaust conduit). The shutter 31 is qualified as controllable in that its configuration inside the exhaust conduit 28 can be varied and, more particularly, controlled depending on the needs. By modifying the configuration of the controllable shutter 31 inside the exhaust conduit 28, the airflow can be varied and even controlled, i.e. a shutter which configuration inside the exhaust conduit 28 can be modified to vary the airflow. By modifying the configuration of the controllable shutter 31, the opening of the exhaust conduit 38 is simultaneously modified from a fully open conduit to a fully closed conduit and vice-versa.

In terms of control, the time constant of the variable speed fan 30 is longer than the time constant of the controllable shutter 31. Hereinafter, the time constant is intended to mean how fast the airflow varies to a change in the speed of the exhaust fan 30 or an opening of the controllable shutter 31. While the airflow can take a few minutes to adjust to a change in the speed of the exhaust fan 30, it takes only a few seconds (between 1 and 5 seconds) to react to a change of the opening of the controllable shutter 31.

A primary filter 34 is mounted to or adjacent to the ventilation hood 26 in proximity to or substantially closing an opening 35 of the ventilation hood 26, above the cooking appliances 24. The primary filter 34 is a degreasing device through which all the air that flows through the ventilation hood 26 first passes. Even though only one section of the primary filter 34 is shown in the schematic example of FIG. 1, it is appreciated that the ventilation system 20 can include several primary filter sections. It is appreciated that several types of primary filters can exist, such as baffle filters.

The primary filter 34 delimits, with the ventilation hood 26, the air filtration chamber 32.

In the embodiment shown, the primary filter 34 is mounted at an oblique angle with respect to the kitchen walls 23. However, it is appreciated that its configuration can differ from the embodiment shown.

The baffle filter, used as primary filter 34, removes some of the unwanted particles from the air as they attach, precipitate, and/or condense onto the various interlocking baffles. The baffle filter 34 can be removable from the ventilation hood 26 to facilitate easier cleaning and/or removal of unwanted particles, such as grease.

The ventilation system 20 also includes one or more than one secondary filter 36, located downstream of the primary filter 34, along an air circuit flowing through the ventilation system 20 between the ventilation hood opening 35 and the exhaust conduit 28. The secondary filter 36 is located inside the air filtration chamber 32. Thus, the air flowing through the ventilation system 20, first flow through the primary filter 34, then into the air filtration chamber 32, to access the secondary filter 36 before exiting through the exhaust conduit 28.

In a non-limitative embodiment, the secondary filter 36 comprises a foam filter. Foam filters are a type of air cleaner filter that use small cells or pockets as the filtering material to trap unwanted air contaminants and particulates. Foam filters are made up of these tiny interlocking cells or pockets that prevent the passage of undesired particles, while simultaneously allowing the passage of air. In some implementations, the foam filter can be a refractory open-cell foam filter. Foam filters have other known uses such as soundproofing, thermal insulation, or other types of filtration, such as filtration for compressed air, exhaust gas, water, metal, or engine oil. Foam filters, including refractory open-cell foam filters, are durable and resistant to fire and flame passage; thus, a foam filter for use in a ventilation hood provides a filter that is resistant to high temperatures, while efficiently reducing the grease, oil or particle content in the exhaust airflow. The foam filters can act as a barrier to prevent a fire in the ventilation hood from spreading to the ventilation system, thus reducing the risk of fire in the ventilation system. Furthermore, foam filters have surprisingly been found to be particularly efficient in the context of ventilation hoods, in part due to these known qualities, but also in that, unlike other types of kitchen ventilation filters, they maintain a better filtration performance at low velocity. This characteristic makes foam filters particularly suitable for ventilation hoods, especially in conjunction with demand ventilation systems. Other characteristics that make foam filters suitable for application in a ventilation hood include, without limitation, having a neutral pH, ability to be regenerated, ability to promote the creation of biofilms, lightweight, modular, and being washable for continued use.

The foam filters described herein can comprise any type of foam or foaming filter, such as refractory open cell foams, including, without limitation ceramic foams, carbon foams, and metal foams, such as metal oxide foams. The refractory open-cell foams can comprise, for example, silicon carbide, zirconium oxide, aluminum oxide or a combination thereof. The refractory open-cell foams are lightweight, porous structures that are configured to allow a forced airflow therethrough, with an exiting airstream having a reduced quantity of unwanted particles.

It is appreciated that, in alternative embodiments (not shown), the secondary filter can include mesh filter(s) and/or bead filter(s).

In the non-limitative embodiment shown, the secondary filter 36 is mounted substantially horizontally. However, it is appreciated that its configuration can differ from the embodiment shown.

The ventilation system 20 also includes a pressure sensor 38 located inside the air ventilation chamber 32, between the primary filter 34 and the secondary filter 36, adjacent to the secondary filter 36. The pressure sensor 38 monitors a pressure difference between ambient air and the air between the two filters 34, 36. The pressure measured by the pressure sensor 38 is indicative of the presence of the at least one primary filter 34. If the pressure measured by the pressure sensor 38 corresponds substantially to the atmospheric pressure, it can be an indicator that the primary filter(s) is not mounted to the ventilation hood 26. As it will be described in more details below, if the primary filter is absent, cleaning of the ventilation system 20 should be avoided.

The ventilation system 20 also includes a drain 40 in liquid communication with the air filtration chamber 32 to allow accumulated grease and cleaning liquid to flow outwardly of the air filtration chamber 32. It is appreciated that the position of the drain 40 can vary from the embodiment shown in FIG. 1 and that the ventilation system 20 can include more than one drain 40.

The ventilation system 20 also includes a cleaning system 42. In the non-limitative embodiment shown, the cleaning system 42 includes at least one upstream washing nozzle 44, which liquid flow is directed towards an upstream (or inlet) surface 46 of the secondary filter 36. In the embodiment shown, the upstream washing nozzle 44 is located inside the air filtration chamber 32, between the primary filter 34 and the secondary filter 36 with respect to the airflow which can flow therethrough.

The cleaning system 42 also includes at least one downstream washing nozzle 48, which liquid flow is directed towards a downstream (or outlet) surface 50 of the secondary filter 36. In the embodiment shown, the downstream washing nozzle 48 is located inside the air filtration chamber 32, between the secondary filter 36 and the exhaust conduit 28 with respect to the airflow which can flow therethrough.

The cleaning system 42 also includes at least one exhaust conduit washing nozzle 52, which liquid flow is directed towards an inlet port 54 of the exhaust conduit 28.

It is appreciated that, even only one upstream, downstream, and exhaust conduit washing nozzles 44, 48, 52 are shown in the non-limitative example of FIG. 1, the cleaning system 42 can include more than one nozzle of each type.

In a non-limitative embodiment, the upstream and downstream conduit washing nozzles 44, 48 are conical nozzles and the exhaust conduit washing nozzle 52 is a pulverization nozzle. In a non-limitative embodiment, the upstream, downstream, and exhaust conduit washing nozzles 44, 48, 52 operates at a pressure ranging between about 40 psi and about 60 psi.

The cleaning system 42 also includes a water supply and a cleaning agent supply (not shown). The upstream, downstream, and exhaust conduit washing nozzles 44, 48, 52 are in liquid communication with the water supply and the cleaning agent supply. Therefore, they can spray a water-based solution containing the cleaning agent towards the secondary filter 36 and the inner wall of the exhaust conduit 28. Conduits connect the water supply and the cleaning agent supply to the upstream, downstream, and exhaust conduit washing nozzles 44, 48, 52. In an embodiment, the water supply is a hot water supply, wherein the water temperature is above about 50° C.

Valves can be mounted to the conduits connecting the water supply and the cleaning agent supply to the upstream, downstream, and exhaust conduit washing nozzles 44, 48, 52 to control respectively the water and cleaning agent flows therein.

In an alternative embodiment, a respective water supply and/or a cleaning agent supply can be associated to each one of the upstream, downstream, and exhaust conduit washing nozzles 44, 48, 52.

Using at least a portion of the above-described commercial cooking assembly, there is provided a method to clean the secondary filter(s) 36 located inside the air filtration chamber 32 of the ventilation system 20.

Using the downstream conduit washing nozzle(s) 48, a first liquid mixture including water and the cleaning agent is sprayed towards the inlet surface 46 of the secondary filter(s) 36. Then, a second liquid mixture, also including water and the cleaning agent, is sprayed towards the outlet surface 50 of the secondary filter(s) 36.

Optionally, using the exhaust conduit washing nozzle(s) 52, a third liquid mixture, also including water and the cleaning agent, is sprayed towards the exhaust conduit 28 of the ventilation system 20.

Therefore, in an embodiment, the first, the second, and the third liquid mixtures are sprayed sequentially. In an alternative embodiment, the first ant the second liquid mixtures can be sprayed sequentially and the third liquid mixture can be sprayed simultaneously with one of the first and the second liquid mixture.

The cleaning agent for the first, second, and third liquid mixture can be the same, a different cleaning agent or a mixture of a plurality of cleaning agents. If the cleaning agent for the first, second, and third liquid mixture is a different one, the cleaning system 42 can include more than one cleaning agent supply. Furthermore, the concentration of the cleaning agent in the first, second, and third liquid mixture can be the same or a different one. The concentration can be controlled by modifying the opening a valve mounted to one of the conduits, between the cleaning agent supply and a respective one of the upstream, downstream, and exhaust conduit washing nozzles 44, 48, 52. In addition, the pressure at which the first, second, and third liquid mixture is sprayed onto the secondary filter(s) 36 and the inner wall of the exhaust conduit 28, respectively, can be the same or can be different.

The water sprayed towards the secondary filter(s) 36 and/or the exhaust conduit 28 can be hot water (e.g. the water temperature is above about 50° C.) supplied by the water supply.

The exhaust air propeller (or exhaust fan) 30 can be used to generate an airflow through the secondary filter(s) 36 while spraying the first liquid mixture and, in some embodiments, while spraying the second liquid mixture. As mentioned above, the airflow enters the secondary filter(s) 36 through the inlet surface 46 and exits through the outlet surface 50. In some embodiments, the airflow generated while spraying the first liquid mixture is greater than the airflow generated while spraying the second liquid mixture. In some embodiments, the second liquid mixture, applied towards the outlet surface 50 of the secondary filter(s) 36, is applied without a forced airflow flowing inside the air filtration chamber 32.

In some embodiments, prior to spraying at least one of the first, the second, and the third liquid mixtures, the presence of the primary filter(s) 34, mounted to the ventilation hood 26, can be verified. The presence/absence of the primary filter(s) 34, mounted to the ventilation hood 26, can be determined using the pressure sensor 38. The pressure sensed by the pressure sensor 38, while an airflow circulates through the ventilation system 20, is indicative of the presence of the presence/absence of the primary filter(s) 34 since it measures a pressure difference between the pressure between the primary and secondary filters 34, 36 and ambient pressure. If the measured pressure indicates that the primary filter(s) 34 is present, the first, the second, and/or the third liquid mixture can be sprayed.

In an embodiment, the airflow rate can be varied when spraying the first liquid mixture. For instance, the controllable shutter 31, which has a shorter time constant than the exhaust fan 30, can be used to relatively quickly vary the airflow rate within the ventilation system 20 and, more particularly, the airflow rate flowing through the secondary filter(s) 36. The opening of the controllable shutter 31 can be varied at a cycle ranging between about 1 second and about 10 seconds, in some other embodiments, at a cycle ranging between about 2 and about 3 seconds and, in some embodiments, at a cycle ranging between about 2 and about 5 seconds to modify the airflow flowing through the at least one secondary filter(s) 36. In some embodiments, the configuration of the controllable shutter 31 can be varied between a fully closed configuration, e.g. the exhaust conduit 28 is closed by the controlled shutter 31, to a fully open configuration, e.g. the controlled shutter 31 substantially does not obstruct the airflow path inside the exhaust conduit 28, at every cycle.

When the airflow rate is higher, the first liquid mixture penetrates deeper in the secondary filter(s) 36. Therefore, by varying relatively quickly the airflow rate, the first liquid mixture flows in both directions inside the secondary filter(s) 36, i.e. towards the inlet surface 46 and the outlet surface 50 sequentially, thereby increasing the washing effect to degrease the secondary filter(s) 36.

As mentioned above, the airflow is generated by the exhaust fan 30, which is characterized by a maximum airflow rate, i.e. the maximum airflow rate that the exhaust fan 30 can generate through the ventilation system 20.

In an embodiment, the airflow rate flowing through the ventilation system 20 when spraying the first liquid mixture ranges between about 0% to about 100% of the maximum airflow rate of the air propeller (or exhaust fan) 30 and, in an embodiment, between about 50% to about 100% of the maximum airflow rate of the air propeller 30.

In an embodiment, the airflow rate flowing through the ventilation system 20 when spraying the second liquid mixture ranges between about 0% to about 25% of the maximum airflow rate of the air propeller 30.

In an embodiment, the airflow rate flowing through the ventilation system 20 when spraying the third liquid mixture ranges between about 75% to about 100% of the maximum airflow rate of the air propeller 30. Therefore, when spraying the second liquid mixture, the airflow rate flowing through the ventilation system 20 can be lower than the airflow rate flowing through the ventilation system 20 when spraying the first liquid mixture and/or the third liquid mixture. The liquid mixture(s) can be sprayed between about 1 to about 5 minutes, depending on the type of cooking.

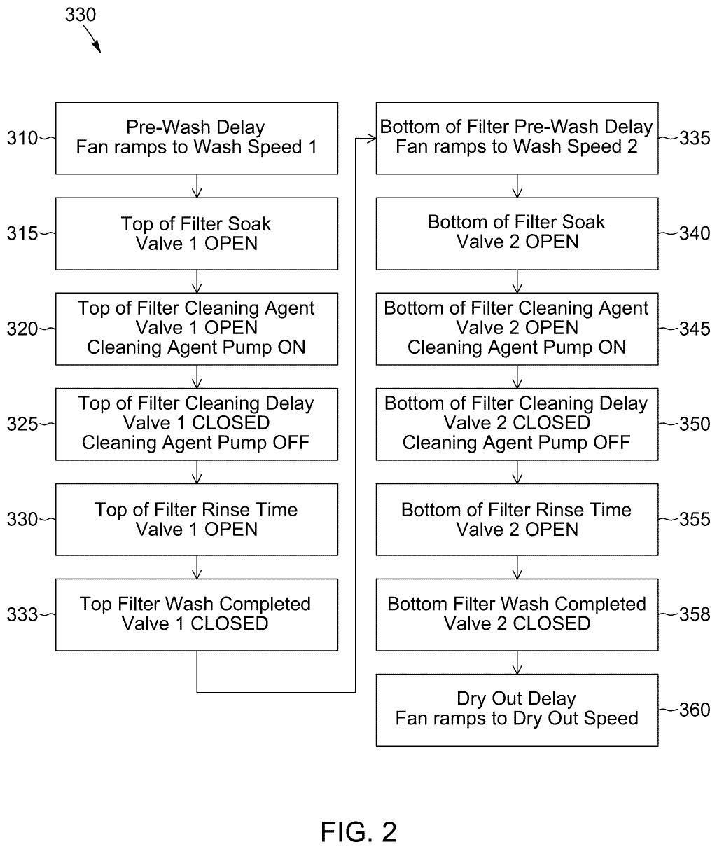

Referring now to FIG. 2, there is shown a particular embodiment of the method 300 for cleaning a secondary filter, such as the secondary filter 36 of the ventilation system 20. As mentioned above, in a first step (not shown), the presence of the primary filter(s) 34, mounted to the ventilation hood 26, can be verified, as described above, by measuring the pressure difference between the pressure between a space located between the primary and secondary filters 34, 36 and ambient pressure. A pressure difference, between the pressure at a location between primary and secondary filters 34, 36 and ambient pressure, indicates that the primary filter(s) 34 is present. Therefore, the first, the second, and/or the third liquid mixture can be sprayed inside the air filtration chamber 32.

Then, the exhaust fan 30 can be activated up to a first speed set-point, e.g. “Wash speed 2”, at step 310. Once the fan speed set-point is reached, a first water supply valve, e.g. the valve associated to the downstream washing nozzle 48, can be open to spray water towards the outlet surface 50 of the secondary filter 36 (step 315). Then, the cleaning agent can be added to the water being sprayed by opening a suitable valve (step 320). Water and the cleaning agent are sprayed during a predetermined time period at a predetermined flowrate towards the outlet surface 50 of the secondary filter 36. In some embodiments, the predetermined time period for spraying water and the cleaning agent ranges between about 1 and about 5 minutes. It is appreciated that, to control the flowrate and the concentration of cleaning agent, the opening the valves can be adjusted. Once the time threshold is reached, at least the cleaning agent valve is closed and, in an embodiment, both the first water supply valve and the cleaning agent valve are closed (step 325). Then, the water supply valve is reopened to rinse the secondary filter 36 from the outlet surface 50 (step 330), e.g. by spraying water from the downstream washing nozzle 48. In another embodiment, the first water supply valve can remain open to rinse the outlet surface 50 while the cleaning agent valve is closed. Once the top of the secondary filter 36 is rinsed, the first water supply valve is closed (step 333).

Then, the exhaust fan set-point 30 can be modified to a second speed set-point (step 335), e.g. “Wash speed 1”. Once the fan speed set-point is reached, a second water supply valve, e.g. the valve associated to the upstream washing nozzle 44, can be open to spray water towards the inlet surface 46 of the secondary filter 36 (step 340). The second speed set-point can be higher than the first speed set-point to generate a greater airflow through the secondary filter 36. Then, the cleaning agent can be added to the water being sprayed by opening a suitable valve (step 345). As for the outlet surface cleaning, water and the cleaning agent are sprayed during a predetermined time period at a predetermined flowrate towards the inlet surface 46 of the secondary filter 36. Once the time threshold is reached, at least the cleaning agent valve is closed and, in an embodiment, both the second water supply valve and the cleaning agent valve are closed (step 350). Then, the second water supply valve is reopened to rinse the secondary filter 36 from the inlet surface 46 (step 355), e.g. by spraying water from the upstream washing nozzle 44. In another embodiment, the second water supply valve can remain open to rinse the inlet surface 46 while the cleaning agent valve is closed. Once the inlet surface 46 of the secondary filter 36 is rinsed, the second water supply valve is closed (step 358).

Finally, the exhaust fan set-point 30 can be modified to a third speed set-point (step 360), e.g. Drying speed, during a predetermined time period or to a humidity level threshold. In some embodiments, the third speed set-point, i.e. the drying speed, can be up to 100% of the fan speed, i.e. full speed.

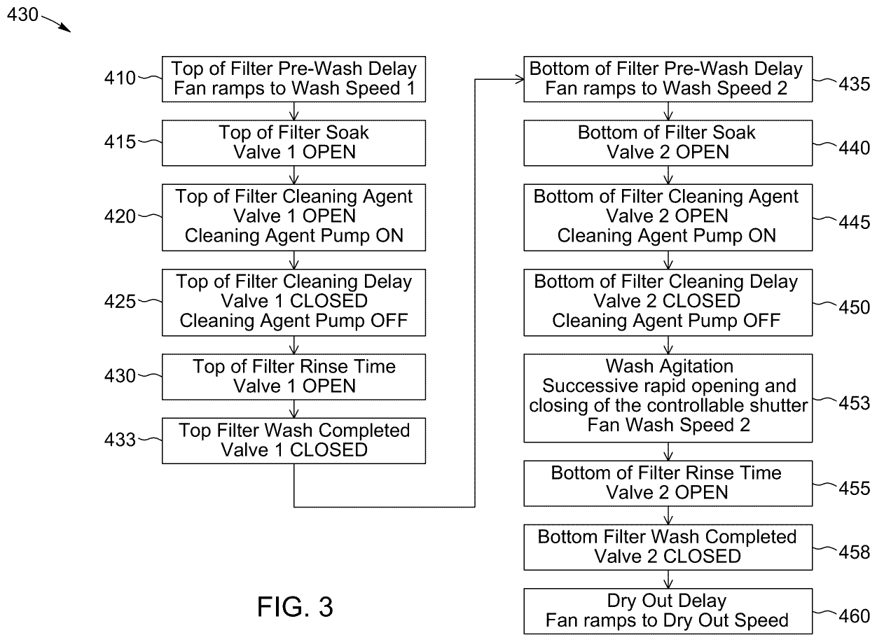

It is appreciated that numerous alternatives to the flowchart of FIG. 2 exists. For instance and without being limitative, FIG. 3 shows an alternative embodiment. For this embodiment, the features are numbered with reference numerals in the 400 series which correspond to the reference numerals of the embodiment of FIG. 2. Most steps being similar between the two embodiments, they will not be further described. However, in the process of FIG. 3, once the cleaning agent has been sprayed on the inlet surface 46 of the secondary filter 36, the configuration of the controllable shutter 31 is modified at a short frequency (e.g. quicker than 10 seconds) to vary the airflow rate within the ventilation system 20 and, more particularly, the airflow rate flowing through the secondary filter 36 (step 453). The opening of the controllable shutter 31 is varied between the fully closed configuration and the fully open configuration at every successive cycle. In some embodiments, between about 4 to about 20 cycles can be performed. The secondary filter 36 is rinsed once the wash agitation cycle (step 453) is completed. During the wash agitation cycle (step 453), the first and the second water supply valves and the cleaning agent valve are closed. For the subsequent rinse cycle, the second water supply valve is reopened.

Once again, it is appreciated that numerous alternatives to the flowchart of FIG. 3 exists. For instance and without being limitative, water and optionally the cleaning agent can be sprayed first towards the inlet surface 46 of the secondary filter 36. The outlet surface 50 can be cleaned after the inlet surface 46.

In some implementations, the exhaust conduit 28 can be washed, for instance, using the exhaust conduit washing nozzle 52, after the secondary filter 36 has been washed and rinsed and before the drying step, i.e. between steps 358 and 360 on FIG. 2 and between steps 458 and 460 on FIG. 3.

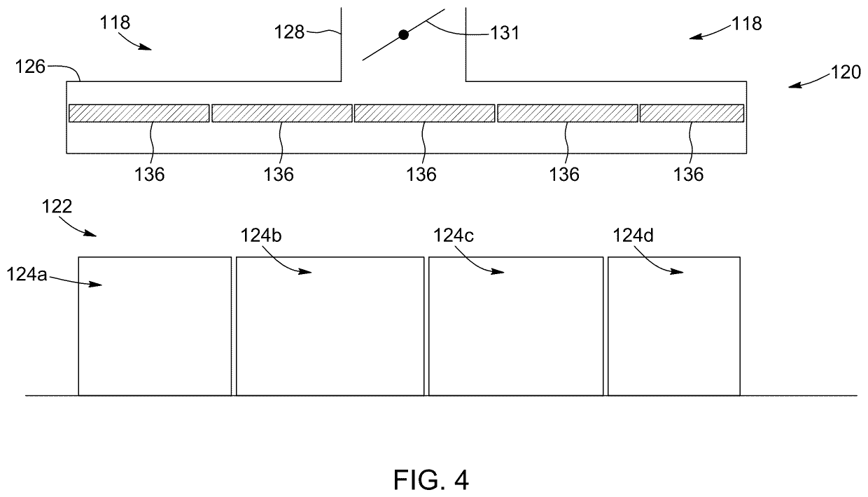

Turning now to FIG. 4, there is shown another schematic embodiment of a commercial cooking assembly 118. For this embodiment, the features are numbered with reference numerals in the 100 series which correspond to the reference numerals of the previous embodiment.

The commercial cooking assembly 118 includes a commercial kitchen 122 including four cooking appliances 124a, 124b, 124c, 124d and a ventilation system 120 located above the cooking appliances 124a, 124b, 124c, 124d. It is appreciated that the number and the position of the cooking appliances can vary from the embodiment shown.

Each one of the cooking appliances 124a, 124b, 124c, 124d is characterized by a maximum ventilation requirement. For this example, the maximum ventilation requirement in CFM/ft (Cubic feet per minute per linear feet) of the cooking appliances 124a, 124b, 124c, 124d are indicated in Table 1.

TABLE 1
Maximum ventilation requirement

| | Length | Maximum | Maximum | |
|---|---|---|---|---|
| | of the | ventilation | ventilation | |
| | cooking | requirement | requirement | |
| Cooking | appliance | per linear | per appliance | % of |
| appliance | in feet (ft) | feet (CFM/ft) | (CFM) | ventilation |
| 124a | 3 | 500 | 1500 | 40% |
| 124b | 3 | 200 | 600 | 16% |
| 124c | 3 | 350 | 1050 | 28% |
| 124d | 3 | 200 | 600 | 16% |
| | | Total | 3750 | |

The ventilation hood 126 can absorb the required airflow, i.e. 3750 CFM. However, due to its configuration, the ventilation hood 126 has a greater airflow in its central portion, under the exhaust conduit 128, than on the lateral sides. In the central portion, the ventilation hood 126 has an airflow of about 350 CFM/linear ft while in both lateral sides, the airflow is about 275 CMF/linear ft.

The cooking appliances 124b and 124c are located in the central portion while each of the cooking appliances 124a and 124d is located in a respective one of the lateral portions. Table 2 below summarized the maximum ventilation requirement of each cooking appliance and the ventilation to each they are submitted.

TABLE 2
Ventilation requirements

| | Maximum | | |
|---|---|---|---|
| | ventilation | | |
| | requirement | Exposed | |
| Cooking | per linear | ventilation | |
| appliance | feet(CFM/ft) | (CFM/ft) | Observation |
| 124a | 500 | 275 | Not enough ventilation |
| 124b | 200 | 350 | The ventilation can be reduced. |
| 124c | 350 | 350 | Not enough ventilation |
| 124d | 200 | 275 | The ventilation can be reduced. |

Thus, the ventilation above the cooking appliances 124a, 124c is insufficient while the ventilation above the cooking appliances 124b, 124d can be reduced.

To redirect the airflow towards the cooking appliances 124a, 124c, the exposed inlet surface area per length unit of the secondary filter(s) 136 above the cooking appliances 124b, 124d can be reduced. Thus, the secondary filter(s) 136 above the cooking appliances 124a, 124c have a greater exposed inlet surface area per length unit than the cooking appliances 124b, 124d.

To modify the exposed inlet surface area per length unit, a secondary filter obstructor can be mounted to the secondary filter(s) 136 located above the cooking appliances 124b, 124d. The secondary filter(s) 136 is characterized by a length and a depth (defining together its surface area). The secondary filter obstructor reduces the exposed surface area of the secondary filter(s) 36 along its depth.

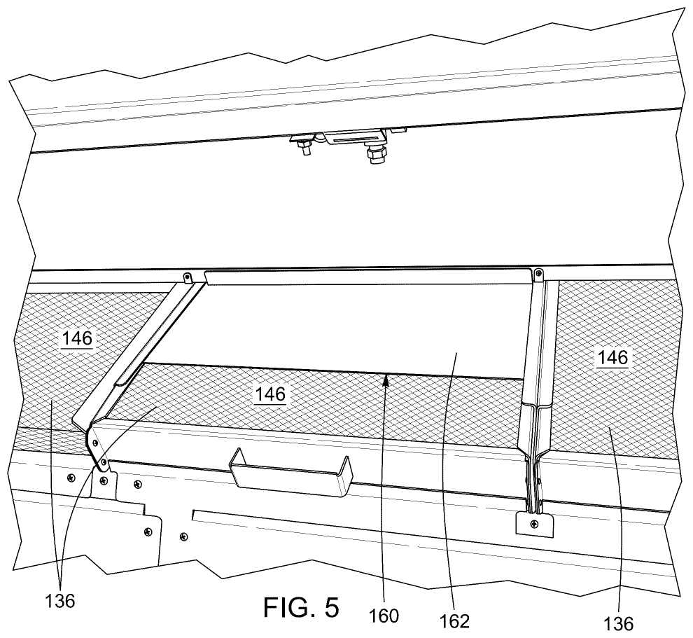

Referring now to FIG. 5, there is shown a non-limitative embodiment of a secondary filter obstructor 160, which comprises a plate 162 superposed to the inlet surface 146 of secondary filter(s) 136. The plate 162 extends along a length of the secondary filter 136, reducing its depth. In the embodiment shown, the plate 162 is removably mounted to a peripheral frame supporting the secondary filter 136.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference the in specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

It will be appreciated that the methods described herein may be performed in the described order, or in any suitable order.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A method to clean at least one secondary filter located inside an air filtration chamber of a ventilation system of a commercial kitchen, the air filtration chamber being in gas communication with an exhaust conduit of the ventilation system, the method comprises:
spraying a first liquid mixture including water and a cleaning agent towards an inlet surface of the at least one secondary filter; and
spraying a second liquid mixture including water and a cleaning agent towards an outlet surface of the at least one secondary filter, wherein spraying the first liquid mixture and spraying the second liquid mixture is carried out sequentially.

2. The method of claim 1, further comprising spraying a third liquid mixture including water and a cleaning agent towards the exhaust conduit of the ventilation system.

3. The method of claim 1, wherein the water sprayed towards the at least one secondary filter is hot water having a temperature greater than about 50° C.

4. The method of claim 1, wherein the at least one secondary filter comprises a ceramic-based foam filter.

5. The method of claim 1, wherein spraying the first liquid mixture is carried out before spraying the second liquid mixture.

6. The method of claim 1, further comprising, while spraying the first liquid mixture, generating an airflow through the at least one secondary filter, the airflow entering the at least one secondary filter through the inlet surface and exiting through the outlet surface.

7. The method of claim 6, wherein the airflow generated while spraying the first liquid mixture is greater than the airflow generated while spraying the second liquid mixture.

8. The method of claim 1, wherein the ventilation system further comprises at least one primary filter delimitating at least partially the air filtration chamber and the method further comprises measuring a pressure between the at least one primary filter and the at least one secondary filter before spraying the first liquid mixture, wherein the measured pressure is indicative of the presence of the at least one primary filter, and spraying the first liquid mixture and the second liquid mixture solely when the at least one primary filter is present.

9. The method of claim 8, wherein the at least one primary filter comprises a baffle filter.

10. The method of claim 6, further comprising varying the airflow when spraying the first liquid mixture.

11. The method of claim 10, wherein the ventilation system further comprises a controllable shutter mounted in the exhaust conduit and the method further comprises varying an opening of the controllable shutter at a cycle ranging between about 1 and about 10 seconds when spraying the first liquid mixture.

12. The method of claim 11, wherein the cycle ranges between about 2 and about 5 seconds to modify the airflow flowing through the at least one secondary filter.

13. The method of claim 11, wherein an opening of the controllable shutter varies from a closed configuration to an open configuration at each one of the cycle.

14. The method of claim 6, wherein the ventilation system further comprises an exhaust air propeller generating the airflow through the ventilation system and wherein the exhaust air propeller is characterized by a maximum airflow rate, and wherein the airflow rate when spraying the first liquid mixture ranges between about 0% to about 100% of the maximum airflow rate of the exhaust air propeller.

15. The method of claim 14, wherein the airflow rate when spraying the first liquid mixture ranges between about 50% to about 100% of the maximum airflow rate of the exhaust air propeller.

16. The method of claim 14, wherein the airflow rate when spraying the second liquid mixture ranges between about 0% to about 25% of the maximum airflow rate of the exhaust air propeller.

17. The method of claim 16, wherein the airflow rate when spraying the third liquid mixture ranges between about 75% to about 100% of the maximum airflow rate of the exhaust air propeller.

18. A commercial cooking assembly comprising:
at least one cooking appliance; and
a ventilation system comprising:
a ventilation hood mounted above the at least one cooking appliance;
at least one primary filter mounted to the ventilation hood and delimitating therewith an air filtration chamber;
at least one secondary filter located inside the air filtration chamber;
an exhaust conduit in gas communication with the air filtration chamber;
an exhaust air propeller generating an airflow at least between an air space located above the at least one cooking appliance, sequentially into the at least one primary filter and the at least one secondary filter located inside the air filtration chamber, and exiting through the exhaust conduit; and
a pressure sensor located between the at least one primary filter and the at least one secondary filter,
wherein the pressure measured by the pressure sensor is indicative of the presence of the at least one primary filter.

19. The commercial cooking assembly of claim 18, wherein the at least one primary filter comprises a baffle filter and the at least one secondary filter comprises a ceramic-based foam filter.

20. The commercial cooking assembly of claim 18, further comprising a cleaning system including at least one upstream washing nozzle oriented towards an upstream surface of the secondary filter, a downstream washing nozzle oriented towards the exhaust conduit, a water supply, and a cleaning agent supply, wherein the upstream, downstream, and exhaust conduit washing nozzles are in liquid communication with the water supply and the cleaning agent supply.
